(19) United States
(12) Patent Application Publication
(10) Pub. No.: US 2025/0265902 A1
(43) Pub. Date: Aug. 21, 2025

(54) PULLTAB GAMING

(71) Applicant: USA Pulltabs LLC, River Falls, WI (US)

(72) Inventors: Anna Schmitz, Vadnais Heights, MN (US); Andrew Schmitz, Vadnais Heights, MN (US)

(73) Assignee: USA Pulltabs LLC, River Falls, WI (US)

(21) Appl. No.: 18/605,766

(22) Filed: Mar. 14, 2024

Related U.S. Application Data
(60) Provisional application No. 63/554,909, filed on Feb. 16, 2024.

(51) Int. Cl. G07F 17/32

(52) U.S. Cl. CPC G07F 17/3246; G07F 17/3223; G07F 17/329; G07F 17/3209

(57) ABSTRACT

A pulltab game includes a set of pulltab cards, wherein each winning card within the set comprises a prize-verification code. In some examples, the prize-verification code is encoded by a barcode printed underneath one of the perforated tabs of the winning card. A prize-redemption kiosk is configured to automatically dispense a cash prize upon verifying the prize-verification code on the winning card. For instance, the prize-redemption kiosk can include a barcode scanner configured to scan the barcode to extract the prize-verification code, and then verify that the prize-verification code has not already been redeemed.

### PRIORITY CLAIM

This U.S. non-provisional utility patent application claims priority to the filing date of U.S. Provisional Patent Application No. 63/554,909, filed on Feb. 16, 2024 and entitled “PULLTAB GAMING.” The entire contents of the provisional patent application are hereby incorporated by reference.

### FIELD OF TECHNOLOGY

The present disclosure generally relates to card-based games and lottery-type games, including collectible trading cards and pulltab games.

### BACKGROUND

“Pulltabs” (or “pull-tabs”) is an incredibly popular lottery-type game played in bars, pubs, breweries, and restaurants throughout the world. Known also by the names “pop-opens,” “break-opens,” and “pickle cards,” pulltabs involves a set of small cardboard cards (or “tickets”) available for purchase by customers of the hosting establishment. Often, a ticket booth staffed by a designated vendor manages sales of the cards, however, bartenders or other employees of the establishment can run the game as well. Typical pulltab cards include two or more cardboard layers coupled together—a bottom layer, featuring one or more randomized gaming entries; and a perforated top layer adhered overtop of the bottom layer to initially conceal the gaming entries. After purchase, the player can rip open a set of perforated strips (or “tabs”) on the top layer of the card in order to reveal the gaming entry concealed underneath. Upon revealing a “winning” gaming entry, the player can return the opened card to the vendor in exchange for a cash prize.

### SUMMARY OF THE INVENTION

Disclosed herein are various example systems, devices, and methods for automating certain aspects of a pulltab game, as well as a set of associated ornamental designs of various components.

In some examples, a pulltab-game system includes: a vending machine configured to retain and dispense a set of pulltab cards of a pulltab game; and a prize kiosk configured to: identify a winning card from the set of pulltab cards; and in response to identifying the winning card, dispense a cash prize associated with the winning card.

In some examples, a prize kiosk of a pulltab-game system includes: means for receiving data comprising a set of game data corresponding to a pulltab game; a digital memory configured to store the set of game data; a barcode scanner configured to scan a barcode printed under a perforated tab on a winning card of the pulltab game; a cash dispenser; and processing circuitry configured to: determine a prize-verification code encoded by the barcode printed on the winning card; locate a winning entry within the set of game data that includes the prize-verification code; determine, from the winning entry, a prize denomination corresponding to the prize-verification code; and cause the cash dispenser to dispense a cash prize corresponding to the prize denomination.

In some examples, a method includes: receiving, by a prize kiosk, a set of game data corresponding to a pulltab game; storing, by the prize kiosk, the set of game data in local memory; scanning, by a prize kiosk, a barcode printed underneath a perforated tab on a winning card of the pulltab game; determining, based on the scanned barcode, a prize-verification code encoded by the barcode; identifying, within the set of game data, a winning entry that comprises the prize-verification code; determining, from the winning entry, a prize denomination associated with the prize-verification code; and dispensing, by the prize kiosk, a cash prize corresponding to the prize denomination.

The aspects, features, advantages, benefits, and objects of the invention will become clear to those skilled in the art by reference to the following description, claims and drawings.

### BRIEF DESCRIPTION OF THE DRAWINGS

FIG. 1 is a conceptual diagram of an automated pulltab-game system, in accordance with techniques of this disclosure.

FIG. 2 is a perspective view of an example pulltab-card vending machine of the system of FIG. 1.

FIG. 3A is a front view of an example collectible pulltab card from the system of FIG. 1A.

FIG. 3B is a back view or rear view of the collectible pulltab card of FIG. 3A, having a set of perforated tabs in a “sealed” or “closed” configuration.

FIG. 3C is a back view of the pulltab card of FIGS. 3A and 3B, with its perforated tabs in an “unsealed” or “open” configuration.

FIG. 4 is a front view of an example prize-redemption kiosk of the system of FIG. 1.

FIG. 5 is a spreadsheet depicting an example of a set of pulltab-game data for the system of FIG. 1.

FIG. 6 is a conceptual block diagram of an example central computer of the pulltab-game system of FIG. 1.

FIG. 7 is a screenshot of an example graphical user interface (GUI) of a website run by the central computer of FIGS. 1 and 6.

FIG. 8 is a screenshot of an example GUI of a customized Customer-Relationship Management software application run by the central computer of FIGS. 1 and 6.

FIG. 9 is a flowchart illustrating a method of running an automatic pulltab game.

FIGS. 10A and 10B illustrate a first example collectible pulltab card of the system of FIG. 1.

FIGS. 11A and 11B illustrate a second example collectible pulltab card of the system of FIG. 1.

FIGS. 12A and 12B illustrate a third example collectible pulltab card of the system of FIG. 1.

FIGS. 13A and 13B illustrate a fourth example collectible pulltab card of the system of FIG. 1.

FIGS. 14A and 14B illustrate a fifth example collectible pulltab card of the system of FIG. 1.

FIGS. 15A and 15B illustrate a sixth example collectible pulltab card of the system of FIG. 1.

FIGS. 16A and 16B illustrate a seventh example collectible pulltab card of the system of FIG. 1.

FIGS. 17A and 17B illustrate an eighth example collectible pulltab card of the system of FIG. 1.

### DETAILED DESCRIPTION

The following disclosure describes, illustrates, and exemplifies one or more embodiments of the present invention. This description is not provided to limit the disclosure to the embodiments described herein, but rather to explain and teach various principles to enable one of ordinary skill in the art to understand these principles and, with that understanding, be able to apply them to practice not only the embodiments described herein, but also other embodiments that may come to mind in accordance with these principles. The scope of the instant disclosure is intended to cover all such embodiments that may fall within the scope of the appended claims, either literally or under the doctrine of equivalents. It should be noted that, in the description and drawings, like or substantially similar elements may be labeled with the same reference numerals. However, sometimes these elements may be labeled with differing numbers in cases where such labeling facilitates a more clear description. Additionally, the drawings set forth herein are not necessarily drawn to scale, and in some instances proportions may have been exaggerated to more clearly depict certain features.

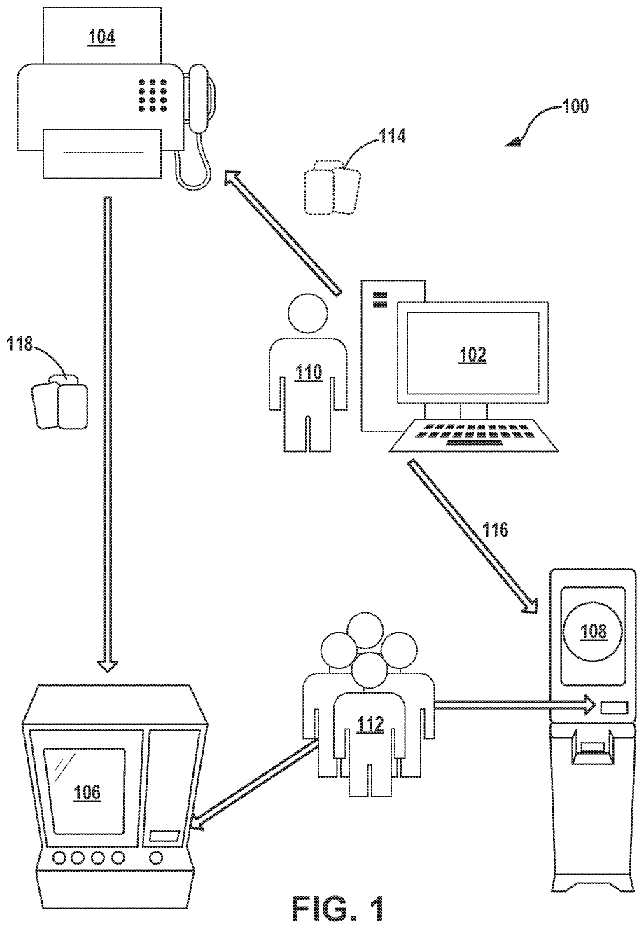

In general, the present disclosure is directed to systems, devices, and techniques for automating one or more functions of a pulltab game, enabling the game to be run faster, cheaper, more accurately, and efficiently scaled to a wider audience. FIG. 1 is a conceptual diagram of an example automatic pulltab-game system 100, in accordance with the techniques of this disclosure. As illustrated in FIG. 1, system 100 includes a central computing device 102 (or “computer 102”); a card printer 104; a card-vending machine 106; and a prize-redemption kiosk 108. Users of (and/or participants in) system 100 include a game manager 110 and a plurality of players 112.

During operation of system 100, game manager 110 uses central computing device 102 to generate a new pulltab game, which includes: (1) a complete set of graphical card images 114; and (2) a corresponding set of game data 116 for automatically identifying the winning game cards and their associated prize information. As elaborated further below, graphical card images 114 include a number of unique features corresponding to game data 116 in order to facilitate automation of the pulltab game.

Game manager 110 instructs central computer 102 to transmit graphical card images 114 to a pulltab-card printer 104 via any suitable data-communication conduit, whether wired (e.g., via a local-area network (LAN)) or wireless (e.g., email transmitted via Wi-Fi). Card printer 104 can include a single printer device (e.g., a standard inkjet/toner printer), up to a designated mass-printing facility, capable of generating a complete set of physical pulltab cards 118 from the graphical card images 114. In accordance with certain aspects of this disclosure, and as detailed further below, pulltab cards 118 can be constructed to provide dual gaming functionality-a front side of each card corresponds to a collectible trading-card game, and a back side of each card corresponds to the pulltab game.

The physical pulltab cards 118 are retrieved from printer 104 and securely deposited within a pulltab-card vending machine 106 at a game-hosting establishment, such as a bar, pub, brewery, or restaurant. Meanwhile, a prize-redemption kiosk 108 is situated locally to the vending machine 106, e.g., either at the same hosting establishment, or within a substantially short (e.g., “walking”) distance. Although FIG. 1 depicts vending machine 106 and prize kiosk 108 as two physically distinct components, in other examples of system 100, vending machine 106 and prize kiosk 108 are integrated within a common housing to form a single device, or equivalently, a single device is configured with the functionality ascribed to both vending machine 106 and prize kiosk 108.

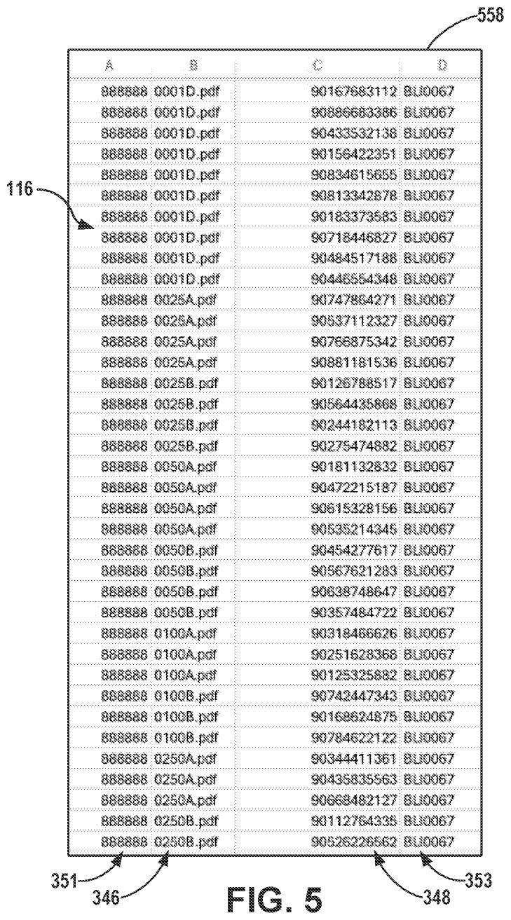

Prize kiosk 108 is configured to receive the set of game data 116 associated with the pulltab cards 118 of a particular game. As detailed further below with respect to FIG. 5, game data 116 can include, for example: a first unique identifier (e.g., a serial number) associated with a particular pulltab game to which all of pulltab cards 118 belong; a second unique identifier for each winning pulltab card from a particular game; and a prize indicator for each winning card. In some cases, game data 116 can be manually uploaded to prize kiosk 108, such as by inserting a USB flash drive (or other suitable removable digital storage volume) and copying the contents into a local memory of kiosk 108. Additionally or alternatively, game data 116 can be remotely transmitted to prize kiosk 108 from central computer 102, such as via a wired and/or wireless network connection.

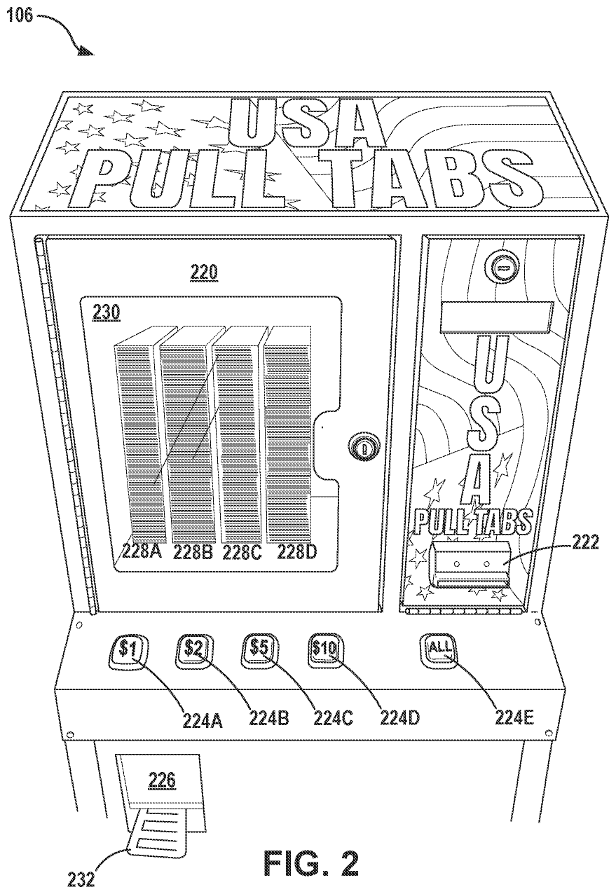

With the physical cards 118 secured within vending machine 106, and with game data 116 uploaded to prize kiosk 108, the pulltab game can begin. Players 112, such as customers or patrons of the hosting establishment, can take turns engaging with vending machine 106, a detailed example of which is shown in FIG. 2.

FIG. 2 is a front-perspective view of an example implementation of the pulltab-card vending machine 106 of FIG. 1. As shown in FIG. 2, vending machine 106 includes: a lockable card safe 220, a cash-deposit slot 222, a plurality of selectable buttons 224, and a pulltab-card-output slot 226.

In the illustrative, non-limiting example depicted in FIG. 2, lockable card safe 220 contains four columns or stacks 228A-228D of pulltab cards, as viewed through transparent window 230. Each column or stack 228 corresponds to one of four different pulltab games running simultaneously. For instance, stack 228A includes pulltab cards available for $1 each, as indicated by button 224A. Stack 228B includes pulltab cards available for $2 each, as indicated by button 224B. Stack 228C includes pulltab cards available for $5 each, as indicated by button 224C. And stack 228D includes pulltab cards available for $10 each, as indicated by button 224D. In other examples, lockable card safe 220 can retain pulltab cards from more, fewer, or different games. For instance, in a different example, columns 228A and 228B could include pulltab cards from the same game, and buttons 224A and 224B would display the same dollar amount for purchase.

During use, a player 112 (FIG. 1) initiates a transaction by depositing cash into the cash-deposit slot 222. Upon receiving cash through cash-deposit slot 222, one or more of buttons may be configured to illuminate, indicating which stacks 228 of pulltab cards the player 112 can select from. For instance, if the player 112 deposited $5, then buttons 224A, 224B, and 224C would illuminate, but not button 224D, as the player 112 did not deposit enough cash to purchase a $10 pulltab card from stack 228D. In that case, the player 112 can select from any combination of buttons 224A-224C to purchase a number of pulltab cards collectively adding up to $5. As a few examples, the player could select button 224A five times; or the player could select button 224A three times and button 224B one time; or the player could select button 224C one time.

Vending machine 106 also includes an “ALL” button 224E. By selecting this button, the player indicates to vending machine 106 that they would like to select “all” of their cards from a common stack 228. For instance, rather than pressing button 224A five times in a row, the player could press the “ALL” button 224E, and then press button 224A, and vending machine 106 will automatically begin grabbing pulltab cards drawn from stack 228A, and dispensing each pulltab card 232 outward through card-output slot 226, until either (1) the player's cash deposit is spent, or (2) the user aborts the dispensing by pressing a different button. Other examples of vending machine 106 can include additional and/or different types of user-input devices other than pressable buttons 224, such as a digital touchscreen, a joystick, a scroll wheel, or any other suitable mechanism for indicating the player's card-stack selection to vending machine 106.

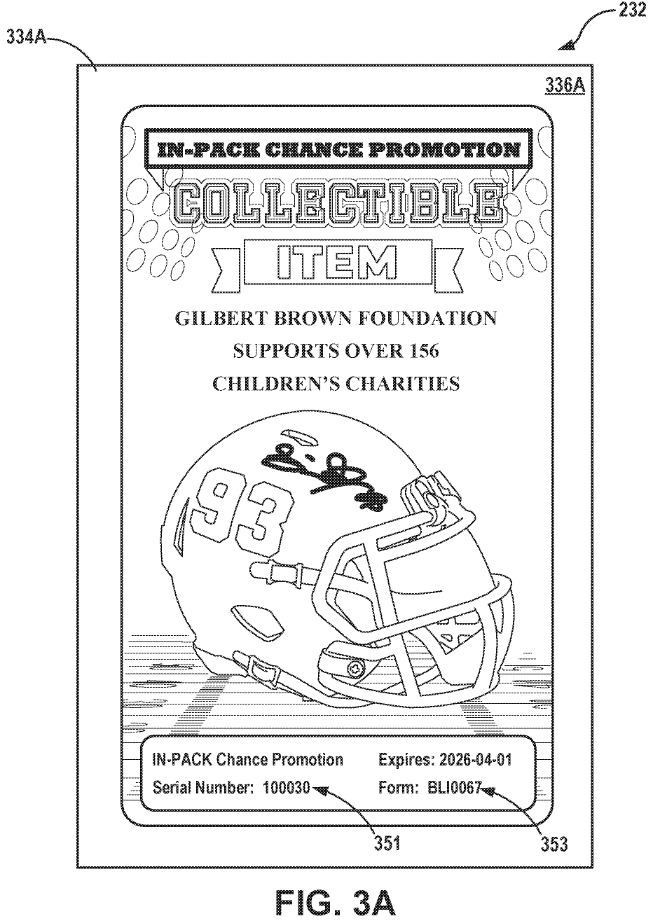

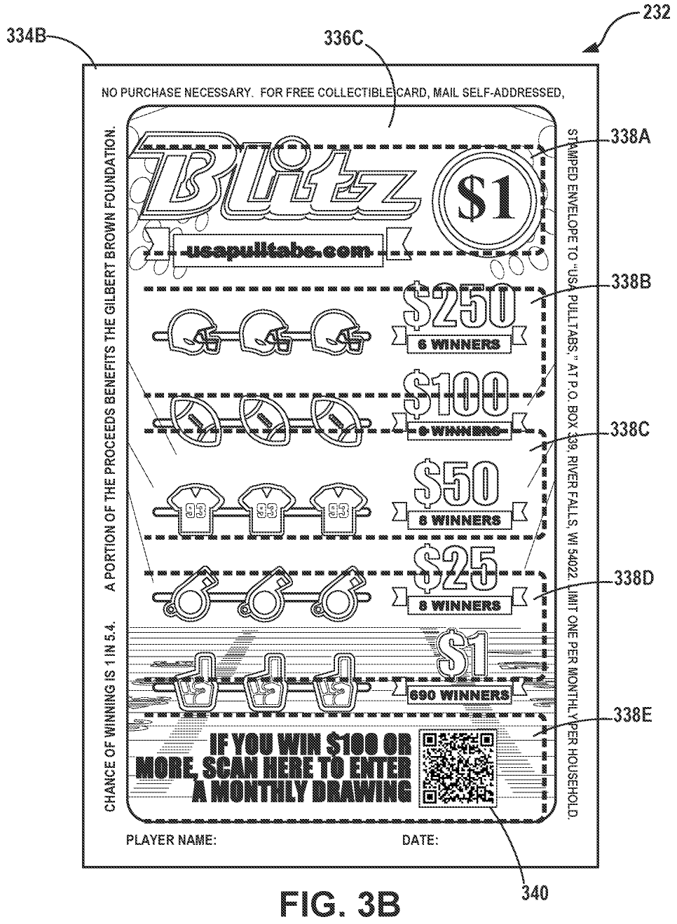

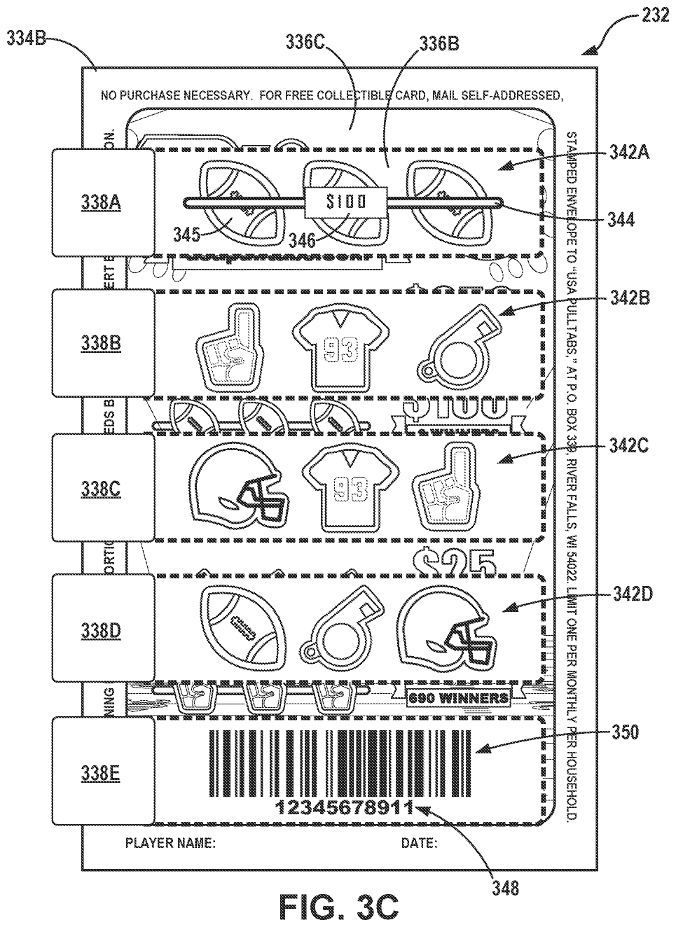

FIGS. 3A-3C depict an illustrative, non-limiting example of a pulltab card 232 that may be dispensed from vending machine 106. Pulltab card 232 of FIGS. 3A-3C is one example of such a card belonging to a larger set of pulltab cards 118 (FIG. 1) associated with a common pulltab game.

As referenced above, pulltab cards of the present disclosure can provide dual gaming functionality. For instance, as shown in FIG. 3A, a front side (or “first” side) 334A of pulltab card 232 corresponds to a collectible trading-card game, e.g., featuring graphical imagery associated with an athlete, an anime character, or any other suitable object that belongs to a larger collection of similar (but non-identical) objects.

Concurrently, as shown in FIGS. 3B and 3C, a back side (or “second” side) 334B of pulltab card 232 corresponds to a pulltab game, in accordance with system 100 described throughout this disclosure. Accordingly, in some examples of the present disclosure, each pulltab card 232 is formed from two layers of material (e.g., cardboard, or the functional equivalent). During manufacture of each card 232, printer 104 (FIG. 1) prints graphical imagery onto both surfaces 336A, 336B of a first cardboard layer, and onto just one surface 336C of the second cardboard layer, and then the two cardboard layers are adhesively assembled into the card. For instance, as depicted in FIG. 3A, a first printed surface 336A of a first cardboard layer constitutes the “collectible” front side 334A of the assembled pulltab card 232. As depicted in FIGS. 3B and 3C, the second surface 336B of the first cardboard layer, and the first surface 336C of the second cardboard layer, collectively form the “pulltab-game” back side 334B of the assembled card 232.

As shown in FIGS. 3B and 3C, the outer surface 336C of the second cardboard layer of pulltab card 232 defines one or more perforated tabs 338A-338E. In this non-limiting example, back-outer surface 336C defines five vertically aligned perforated tabs 338; other examples of pulltab card 232 can include more than five tabs or fewer than five tabs, as desired. As detailed further below, the back-outer surface 336C further includes a quick-response (“QR”) code 340.

The second cardboard layer is adhered onto the back surface 336B of the first cardboard layer, such that back-inner surface 336B of the first cardboard layer and the back-outer surface 336C of the second cardboard layer face the same direction, i.e., opposite from the direction of the front surface 336A of the first cardboard layer.

In the example shown in FIG. 3C, the player 112 (FIG. 1) has ripped open all five perforated tabs 338A-338E of the second cardboard layer, thereby revealing certain portions of the printed back surface 336B of the first cardboard layer thereunder. Specifically, the printed back surface 336B of the first cardboard layer includes one or more pulltab-game entries 342A-342D, with each game entry 342 strategically positioned underneath a respective perforated tab 338A-338D of the second cardboard layer.

For instance, upon tearing open the first perforated tab 338A, the player 112 discovers that the game entry 342A concealed underneath the tab 338A includes a particular sequence of icons 345 (depicted here as three consecutive football-shaped icons), which, under the rules of the corresponding pulltab game, constitutes a winning game entry 342—thus, pulltab card 232 is a winning card.

At the time each pulltab game is originally generated, central computer 102 (FIG. 1) automatically identifies all of the winning game entries for that game, and graphically marks the winning game entries with a horizontal line 344 (which printer 104 prints onto the back surface 336B of the first cardboard layer), in order to simplify and expedite the game for player 112. Additionally, upon generating a winning game entry 342A, computing device 102 determines a cash prize associated with the winning sequence of icons 345, and generates a numerical cash-prize indication 346 overtop of the winning game entry 342A (or, in other examples, overtop of a different (non-winning) game entry 342B-342D on the same card 232).

Even further, in accordance with the techniques of this disclosure, computing device 102, upon generating a winning game entry 342A, is configured to designate the winning card 232 with a unique identifier, thereby enabling automation of a subsequent portion of the game in which player 112 collects their cash prize. In FIG. 3C, this unique identifier is printed onto the back surface 336B of the first cardboard layer and strategically concealed beneath the fifth perforated tab 338E, and includes both a numeric (or alphanumeric) prize-verification code 348, and a machine-readable barcode 350 that digitally encodes the prize-verification code 348.

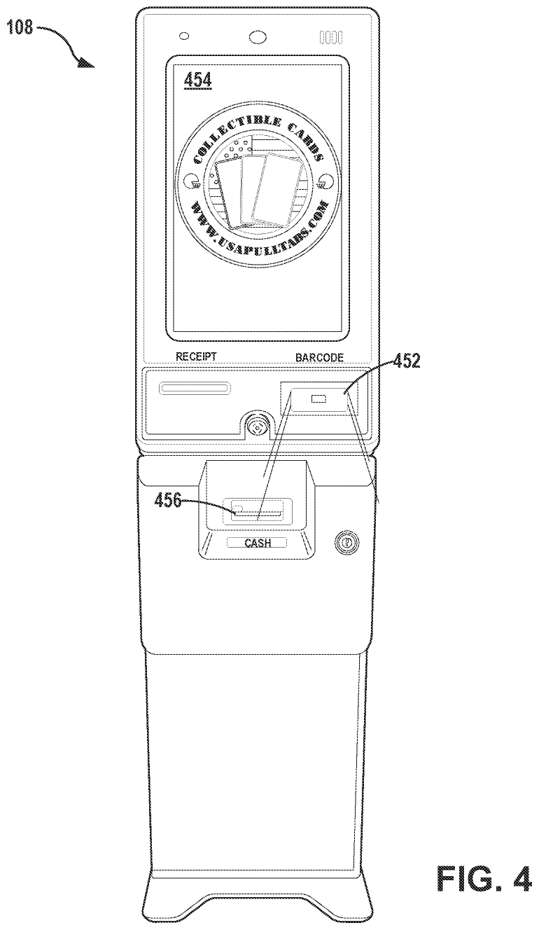

In the example shown, prize-verification code 348 and barcode 350 occupy the space on the printed back surface 336B of the first cardboard layer that would otherwise be occupied by a fifth game entry. But since pulltab card 232 is already a winning card, game entries other than the winning game entry 342A are not necessary to be included on the same card. Prize-verification code 348 is shown in FIG. 3C as an eleven-digit numeric sequence, although other sequences are also contemplated, such as a six-character or seven-character alphanumeric sequence (as just two examples). The prize-verification code 348 is mapped, within game data 116 (FIG. 1), to a unique “game” serial number 351 (FIG. 3A) indicating which pulltab game the card 232 belongs to, when game data 116 is originally generated by central computer 102. After tearing open fifth perforated tab 338E to reveal barcode 350, the winning player 112 can bring the winning card 232 to prize-redemption kiosk 108, an example of which is shown in FIG. 4. FIG. 4 is a front view of an example implementation of prize-redemption kiosk (or “prize kiosk”) 108 of FIG. 1. As shown in FIG. 4, prize kiosk 108 includes an integrated barcode scanner 452. Upon detecting a valid barcode 350 (FIG. 3C) placed in front of the scanner 452, prize kiosk 108 is configured to extract the prize-verification code 348 encoded by the barcode 350, and compare the prize-verification code 348 to game data 116 stored in the internal digital memory of prize kiosk 108. Additionally or alternatively, prize kiosk 108 can include a user interface 454, such as a digital touchscreen displaying a graphical user interface (GUI), that enables player 112 to manually enter the prize-verification code 348 from winning card 232. If prize kiosk 108 identifies a match between the prize-verification code 348 and game data 116, it will automatically dispense a corresponding amount of prize money from cash dispenser 456.

FIG. 5 is a spreadsheet 558 illustrating an example set of game data 116 that might be generated by computing device 102 (FIG. 1) and then uploaded to prize kiosk 108. In this example, game data 116 is formatted as a Comma-Separated Values (“.CSV”) file with four data parameters (e.g., columns) for each entry (e.g., row), wherein each entry represents a different winning pulltab card from the same pulltab game. Column A encodes the unique “game” serial number 351 assigned to each pulltab game. Column B encodes a dollar amount 346 of the cash prize for the pulltab card corresponding to that row. For instance, in the value “0001D.pdf,” the number “0001” represents a prize amount of $1, and the letter “D” indicates which game entry 342 (e.g., the fourth game entry 342D concealed underneath the fourth perforated tab 338D) was the winning game entry on the card. Column C encodes the prize-verification code 348 for a winning pulltab card, which is also encoded by the barcode 350. And Column D encodes an artwork template identifier (ID) 353, which is used by printer 104 when printing physical cards 118.

When a winning player 112 collects a cash prize by scanning the barcode 350 on the barcode scanner 452 of prize kiosk 108, the prize kiosk is configured to automatically store an indication that the associated prize-verification code 348 has been claimed, e.g., so that the same prize cannot be collected multiple times. This, and other related gameplay data is collected and transferred back to game manager 110 for further analysis via custom software running on central computer 102.

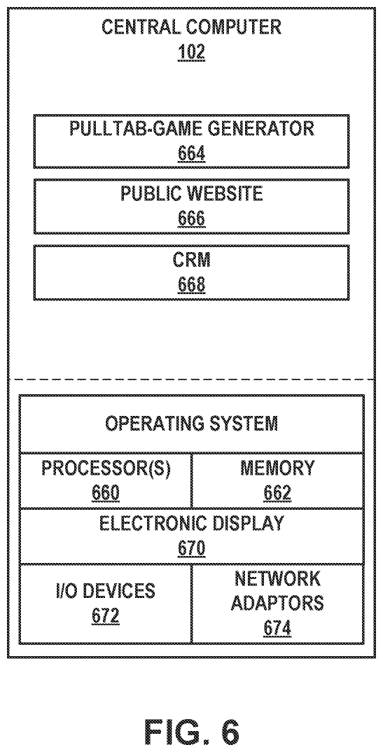

FIG. 6 is a conceptual block diagram of an example implementation of central computer 102 of FIG. 1. Although depicted in FIG. 6 as a single functional unit, in practice, central computer 102 can be or can include one or more communicatively-connected computing devices, e.g., each having a unique processor (or “processing circuitry”) 660 and/or a digital memory 662. Memory 662 encodes one or more software applications (“apps” or “modules”) for generating and managing pulltab games.

For instance, as shown in FIG. 6, central computer 102 is configured to run or execute a pulltab-game generator 664. When executed, game generator 664 is configured to automatically generate a new pulltab game that includes a set of game data 116 (e.g. a .csv file), and corresponding digital pulltab-card images 114 (e.g., a .jpg, .bmp, .webp file etc.), each featuring randomized sets of game entries 342 (FIG. 3C).

Central computer 102 is further configured to host (e.g., store in memory 662) and run (e.g., execute) a public-facing website 666, accessible via the Internet. Players 112 can access website 666 with, for instance, a personal computer, laptop, smartphone, smartwatch, or tablet, in order to learn more information about a pulltab game, or in some cases, to enroll in an additional bonus game.

As one example, a winning player 112 can use their smartphone to scan the quick-response (“QR”) code 340 (FIG. 3B) on the back side 334B of their winning pulltab card 232. The QR code 340 will direct their smartphone's mobile browser to website 666, where player 112 can enter a “second-chance” drawing to win an additional prize.

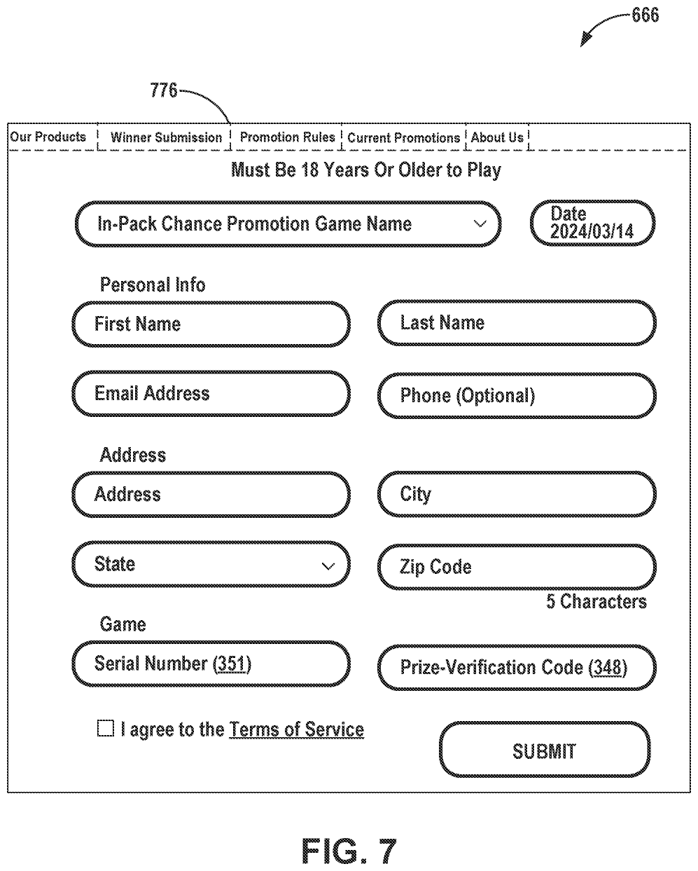

FIG. 7 is a screenshot of an example graphical user interface (GUI) 776 of public-facing website 666 of FIG. 6. As shown in FIG. 7, GUI 776 enables a winning player 112 to submit their name, contact info, and the prize-verification code 348 from their winning card 232 in order to be entered into a periodic, randomized “second-chance” drawing to win an additional prize. The drawing can occur weekly, monthly, semi-annually, or annually, as a few illustrative examples.

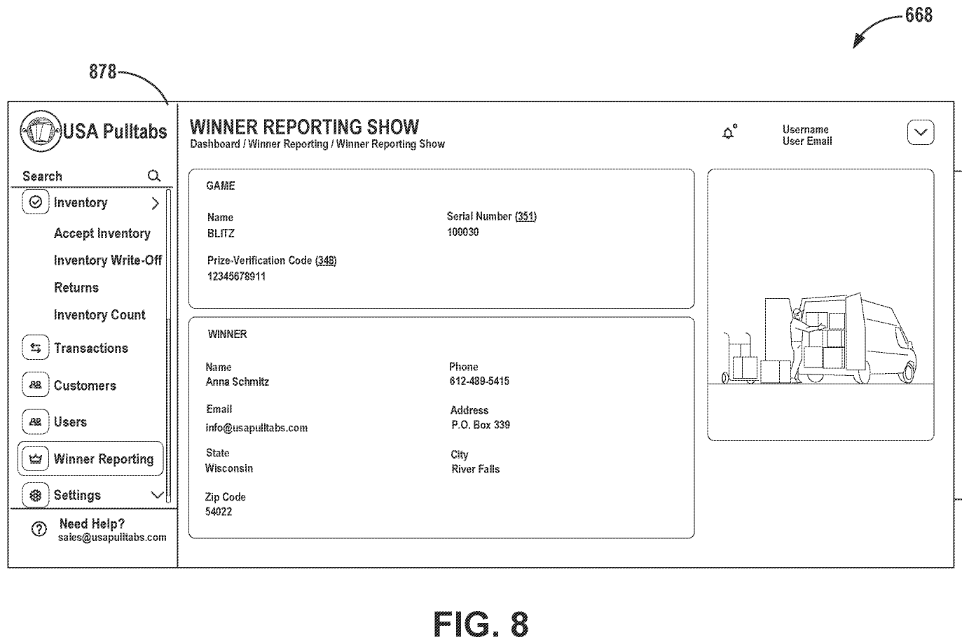

The public-facing website 666 can be configured to interface with a customized Customer-Relationship-Management (CRM) software application 668 run by central computer 102 of FIG. 6. FIG. 8 is a screenshot of an example GUI 878 of CRM software 668 of FIG. 6. For instance, CRM GUI 878 may be generated by processor(s) 660 of central computer 102 and output for display via electronic display screen 670.

As shown in the example GUI 878 of FIG. 8, CRM software 668 is configured to receive, via website 666, the second-chance drawing entry data from winning player 112. Additionally, game manager 110 can upload game data 116 to CRM software 668, in order to verify the winning player's prize-verification code and confirm their entry into the drawing. Equivalently, game generator 664 can automatically upload game data 116 to CRM software 668 every time it generates a new pulltab game. In some examples, CRM software 668 is configured to run all drawing entries through a validation process by matching each player's entry (e.g., game serial number 351, name of pulltab game, and prize-verification code 348) with game data 116 stored in memory 662. If CRM software 668 validates a player's entry, the player's entry receives an positive-validation indicator within GUI 878, such as by displaying that player's entry in green. In one non-limiting, illustrative example, CRM software 668 can be configured to help run the drawing annually by randomly selecting among all the player entries submitted during the previous calendar year (i.e., January 1 through December 31). The winner of the drawing can be contacted directly using the player's entry data, and announced publicly on website 666. Through CRM software 668, every drawing entry is assigned a drawing date to help differentiate between different promotions (e.g., subsequent years' drawings).

In some examples, CRM software 668 can also use the player's drawing-entry data to keep track of the number of redeemed winning pulltab cards 232 for each game, as they are purchased and opened over time. Such data can help inform pulltab-game inventory management, another function performed by CRM software 668. For instance, game manager(s) 110 can use CRM software 668 to help decide whether to either increase or decrease the rate at which new pulltab games are generated, based on the rate at which winning cards 232 are purchased and redeemed.

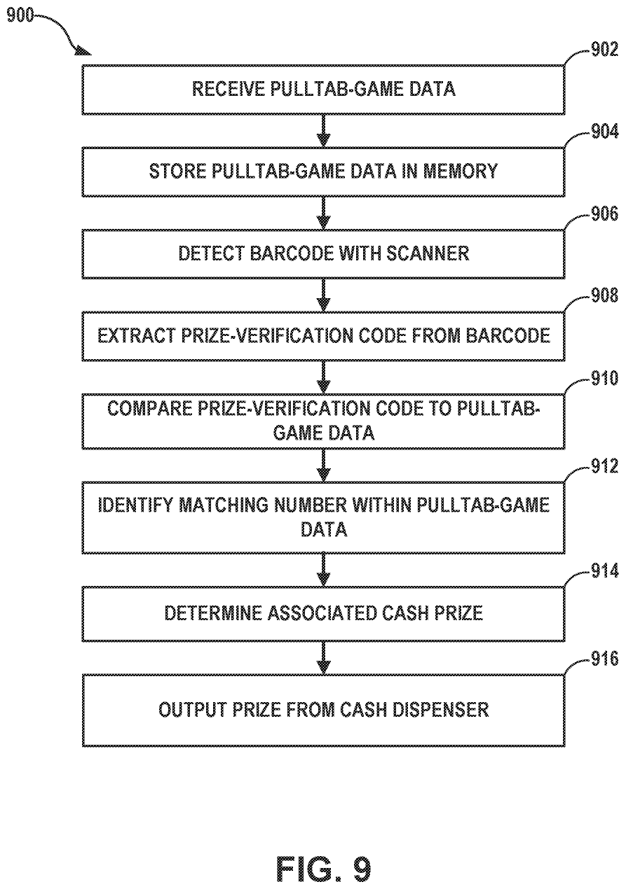

FIG. 9 is a flowchart illustrating a method or process 900 for automating one or more aspects of a pulltab game. Process 900 is described from the perspective of prize-redemption kiosk 108 of FIGS. 1 and 4.

At Step 902, prize kiosk 108 receives a set of game data 116 for a new pulltab game, either locally, e.g., from a removable digital storage inserted into the kiosk, or remotely, e.g., via the Internet from a central computer 102. At Step 904, prize kiosk 108 stores a copy of game data 116 in its local memory.

At Step 906, prize kiosk 108 detects a barcode 350 on a pulltab card 232 placed in front of its integrated barcode scanner 452. Barcode scanner 452 scans the barcode 350, and at Step 908, extracts the prize-verification code 348 encoded by the barcode 350. At Step 910, prize kiosk 108 compares the prize-verification code 348 to the complete set of prize-verification codes included in game data 116. At Step 912, prize kiosk 108 identifies a matching number, and also verifies that prize-verification code 348 has not yet been redeemed, thereby confirming that pulltab card 232 is a valid, winning card. In such cases, at Step 914, prize kiosk 108 retrieves, from game data 116, a prize denomination corresponding to prize-verification code 348, and at Step 916, automatically dispenses a cash prize from prize dispenser 456, in an amount corresponding to the prize denomination.

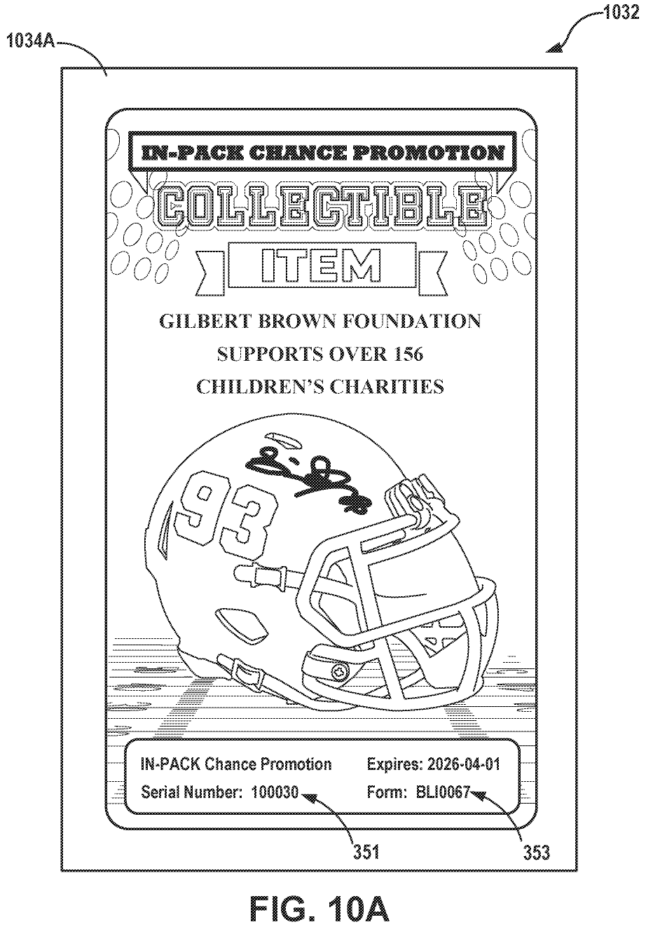

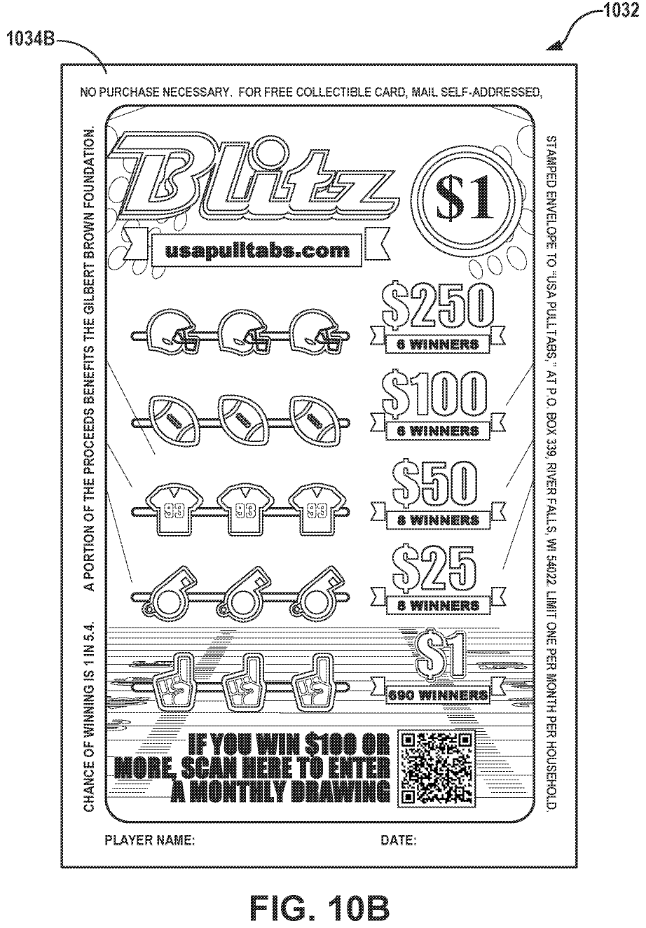

FIGS. 10A-17B collectively illustrate an example set of pulltab cards, such as the set of cards 118 of FIG. 1. For instance, FIG. 10A shows a front side 1034A, and FIG. 10B shows a back side 1034B, of an example pulltab card 1032 that may be printed (by printer 104) and assembled as one of pulltab cards 118. Specifically, pulltab card 1032 is an example of pulltab card 232 depicted in FIGS. 3A-3C. As referenced above, pulltab cards of the present disclosure can include dual gaming functionality. The back side 1034B of card 1032, shown in FIG. 10B, can include one or more tearable perforated tabs 338 (FIG. 3B, not shown in FIG. 10B) as part of a pulltab game. Simultaneously, the front side 1034A of card 1032, shown in FIG. 10A, includes a graphical design such that pulltab card 1032 simultaneously functions as a collectible trading card. Specifically, in the example of FIG. 10A, the front side 1034A of pulltab card 1032 includes a signature and symbol representing a famous athlete. In this example, the front side 1034A of card 1032 also indicates the “game” serial number 351 that identifies which pulltab game the card 1032 belongs to, as well as the artwork template ID 353.

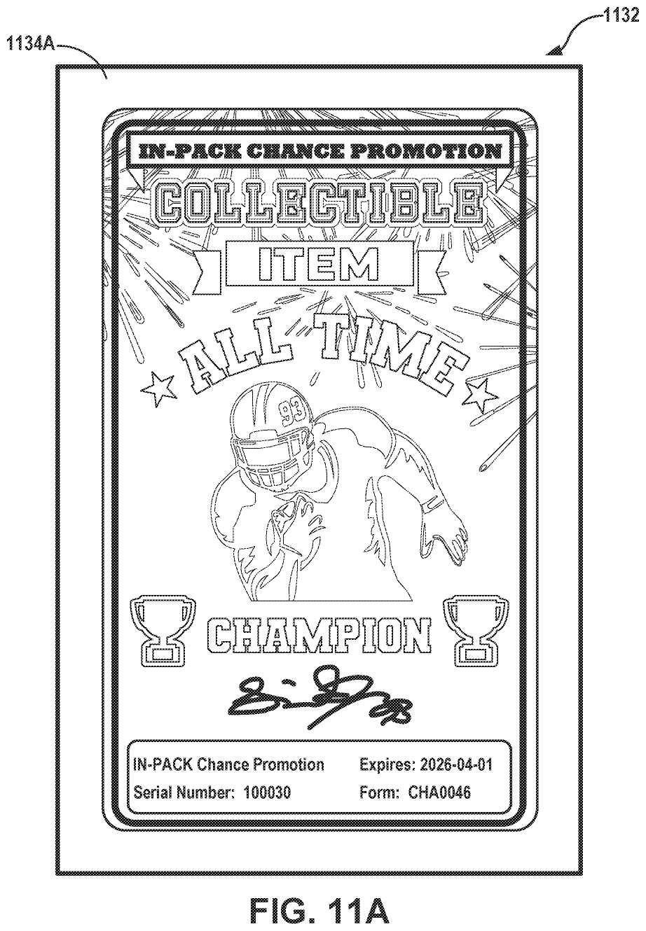

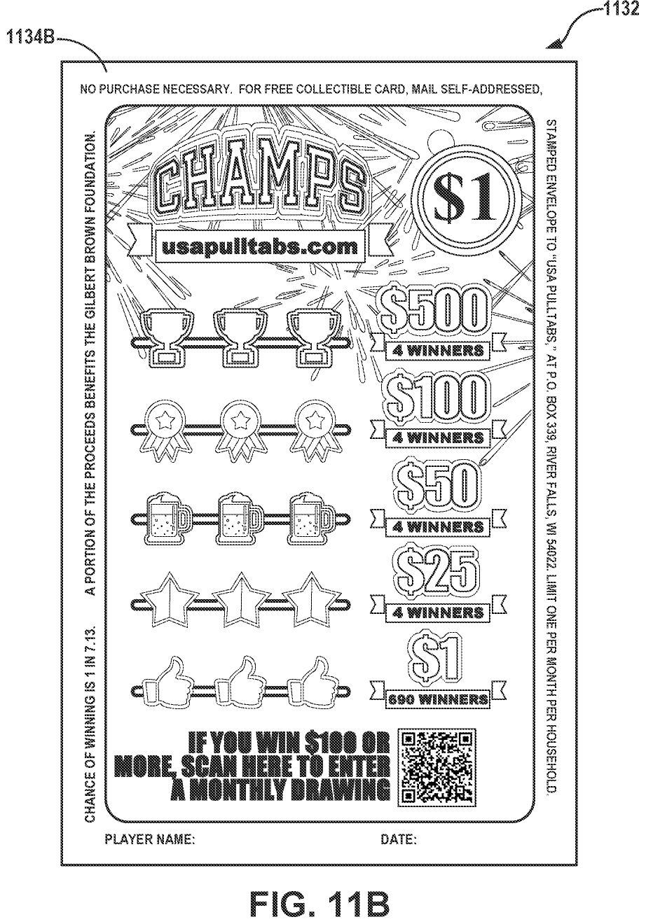

FIG. 11A shows a front side 1134A, and FIG. 11B shows a back side 1134B, of another example pulltab card 1132 that may be printed (by printer 104) and assembled as one of pulltab cards 118 of FIG. 1. Pulltab card 1132 is another example of pulltab card 232 depicted in FIGS. 3A-3C in that, while not explicitly shown, the back side 1134B includes a plurality of perforated tabs concealing respective pulltab-game entries. In the event that one of the concealed game entries is a winning entry, the back side 1134B will further feature, underneath another one of the perforated tabs, a barcode encoding a prize-verification code that may be scanned by prize-redemption kiosk 108 of FIGS. 1 and 4.

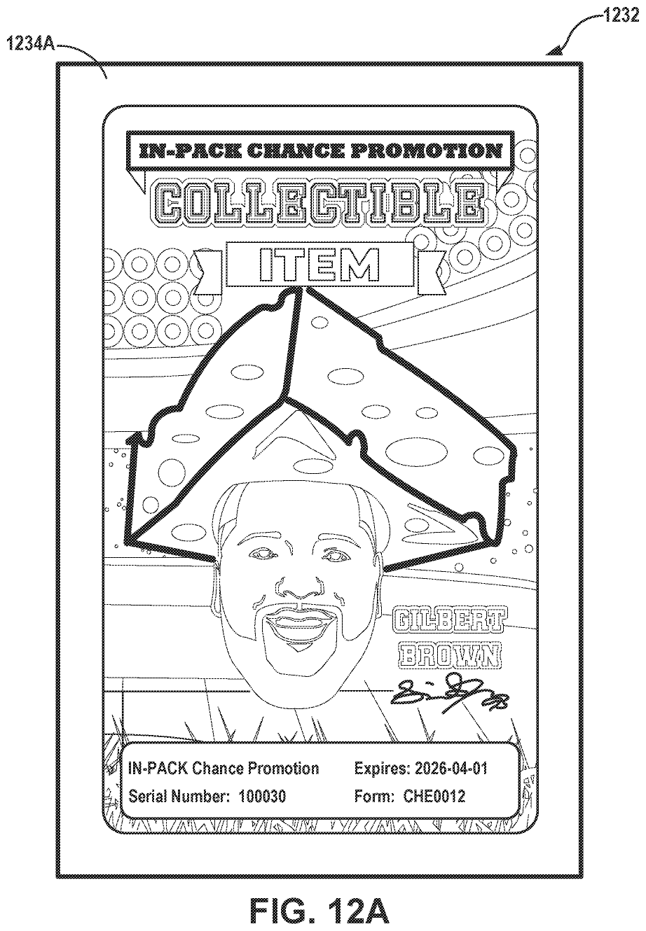

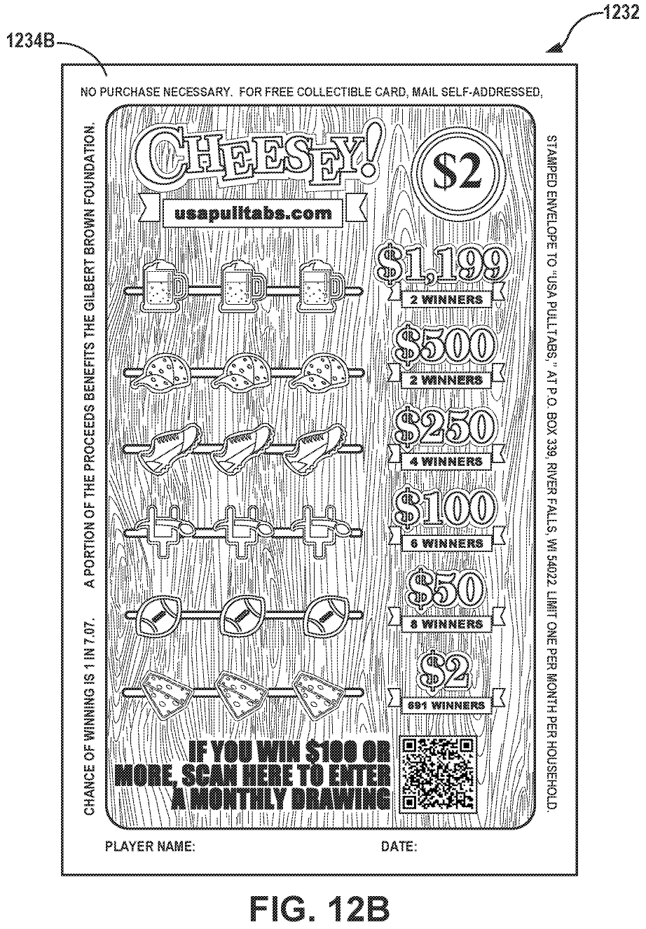

FIG. 12A shows a front side 1234A, and FIG. 12B shows a back side 1234B, of another example pulltab card 1232 that may be printed (by printer 104) and assembled as one of pulltab cards 118 of FIG. 1. Pulltab card 1232 is another example of pulltab card 232 depicted in FIGS. 3A-3C in that, while not explicitly shown, the back side 1234B includes a plurality of perforated tabs concealing respective pulltab-game entries. In the event that one of the concealed game entries is a winning entry, the back side 1234B will further feature, underneath another one of the perforated tabs, a barcode encoding a prize-verification code that may be scanned by prize-redemption kiosk 108 of FIGS. 1 and 4.

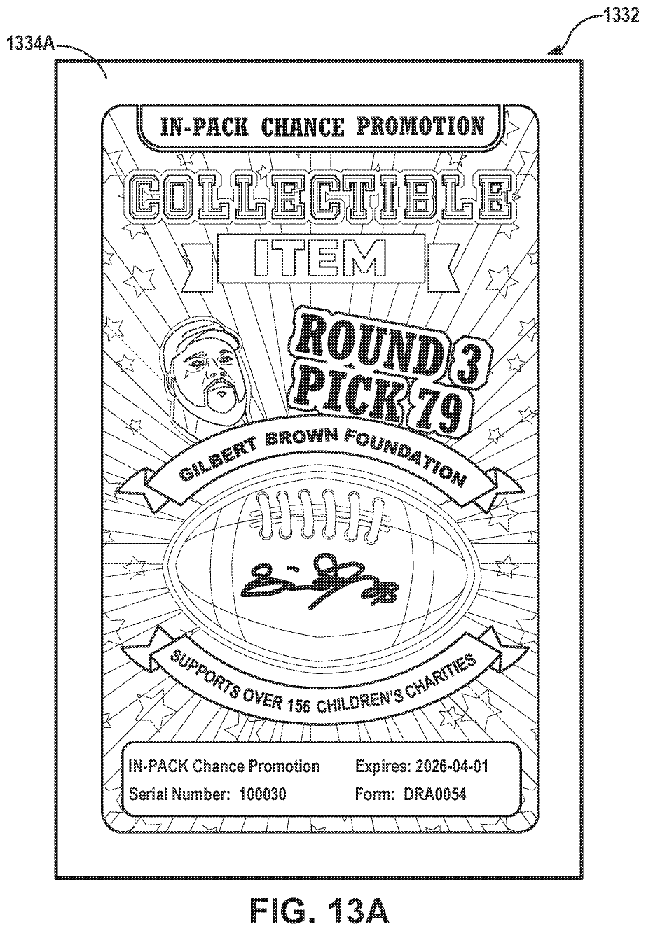

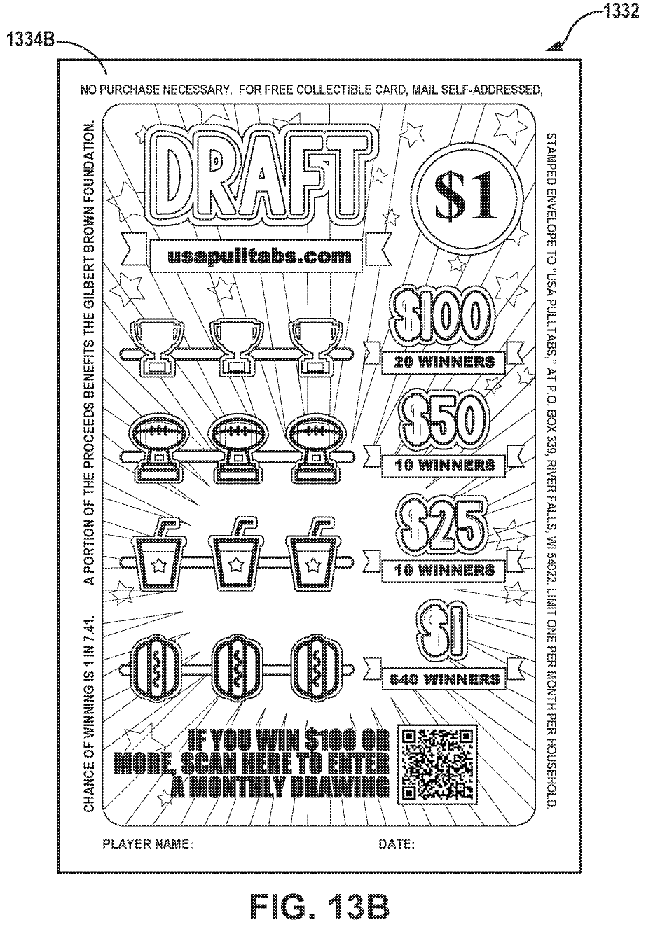

FIG. 13A shows a front side 1334A, and FIG. 13B shows a back side 1334B, of another example pulltab card 1332 that may be printed (by printer 104) and assembled as one of pulltab cards 118 of FIG. 1. Pulltab card 1332 is another example of pulltab card 232 depicted in FIGS. 3A-3C in that, while not explicitly shown, the back side 1334B includes a plurality of perforated tabs concealing respective pulltab-game entries. In the event that one of the concealed game entries is a winning entry, the back side 1334B will further feature, underneath another one of the perforated tabs, a barcode encoding a prize-verification code that may be scanned by prize-redemption kiosk 108 of FIGS. 1 and 4.

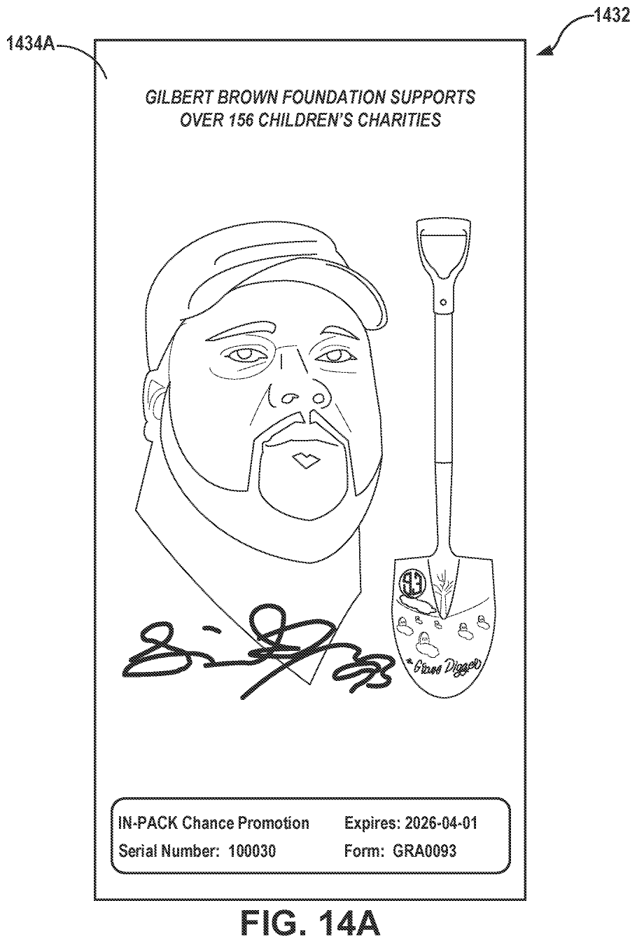

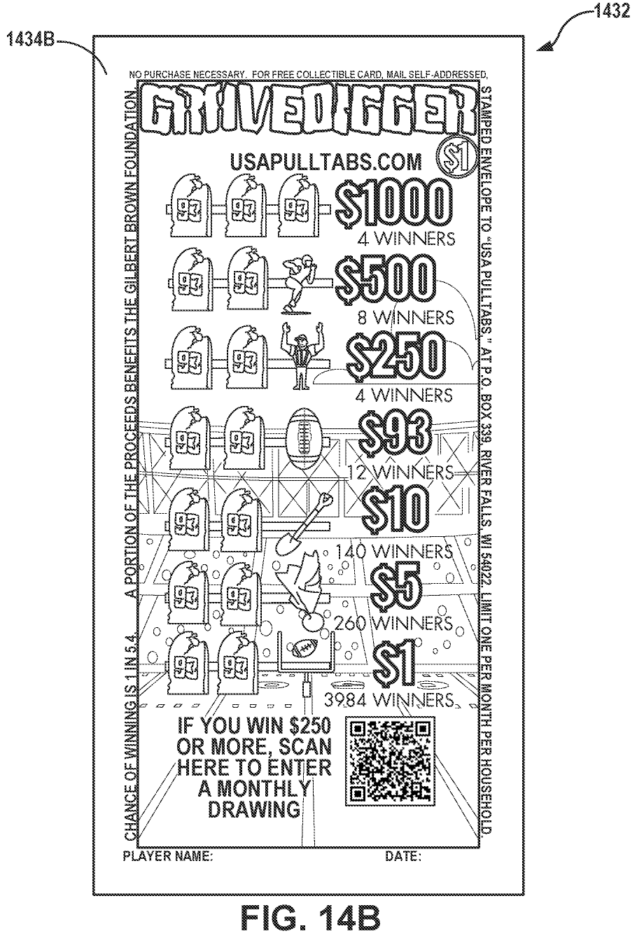

FIG. 14A shows a front side 1434A, and FIG. 14B shows a back side 1434B, of another example pulltab card 1432 that may be printed (by printer 104) and assembled as one of pulltab cards 118 of FIG. 1. Pulltab card 1432 is another example of pulltab card 232 depicted in FIGS. 3A-3C in that, while not explicitly shown, the back side 1434B includes a plurality of perforated tabs concealing respective pulltab-game entries. In the event that one of the concealed game entries is a winning entry, the back side 1434B will further feature, underneath another one of the perforated tabs, a barcode encoding a prize-verification code that may be scanned by prize-redemption kiosk 108 of FIGS. 1 and 4.

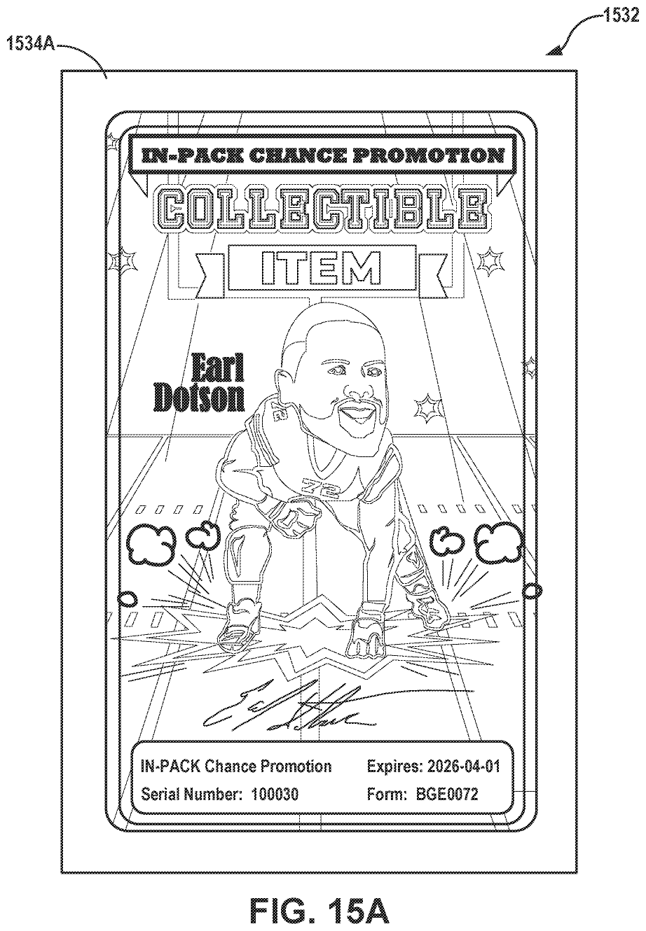

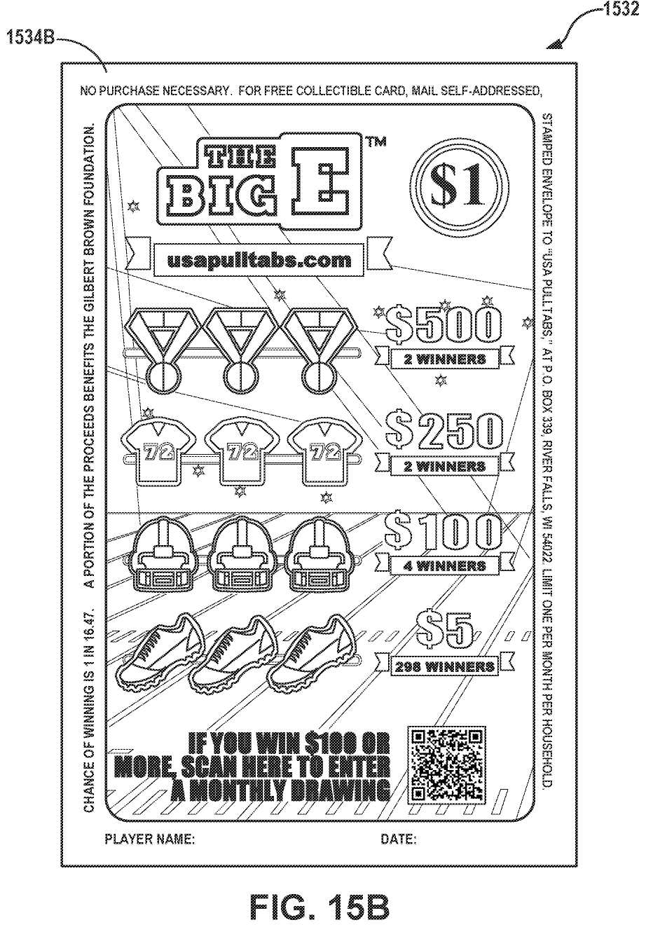

FIG. 15A shows a front side 1534A, and FIG. 15B shows a back side 1534B, of another example pulltab card 1532 that may be printed (by printer 104) and assembled as one of pulltab cards 118 of FIG. 1. Pulltab card 1532 is another example of pulltab card 232 depicted in FIGS. 3A-3C in that, while not explicitly shown, the back side 1534B includes a plurality of perforated tabs concealing respective pulltab-game entries. In the event that one of the concealed game entries is a winning entry, the back side 1534B will further feature, underneath another one of the perforated tabs, a barcode encoding a prize-verification code that may be scanned by prize-redemption kiosk 108 of FIGS. 1 and 4.

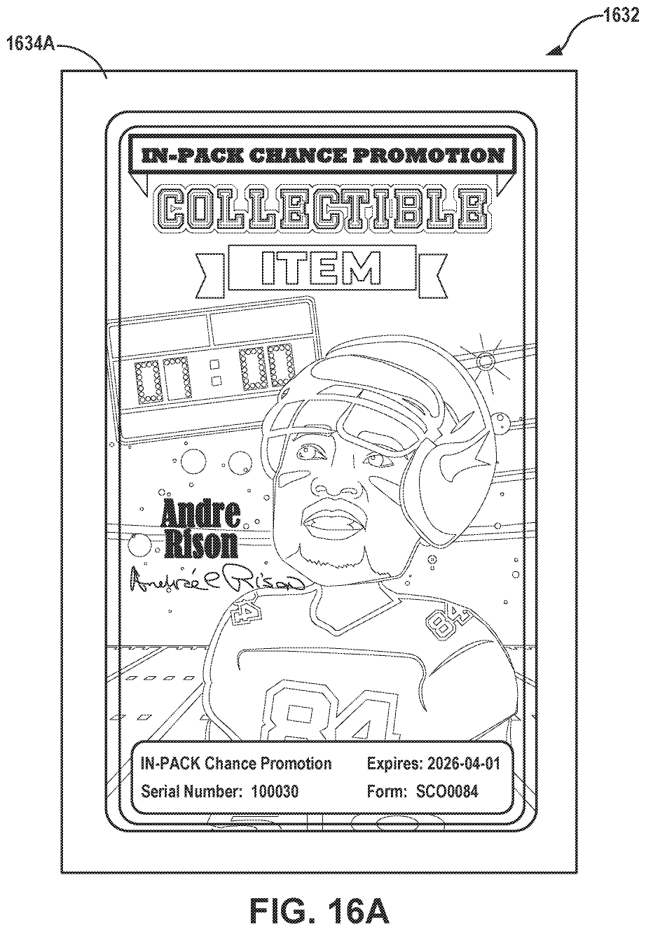

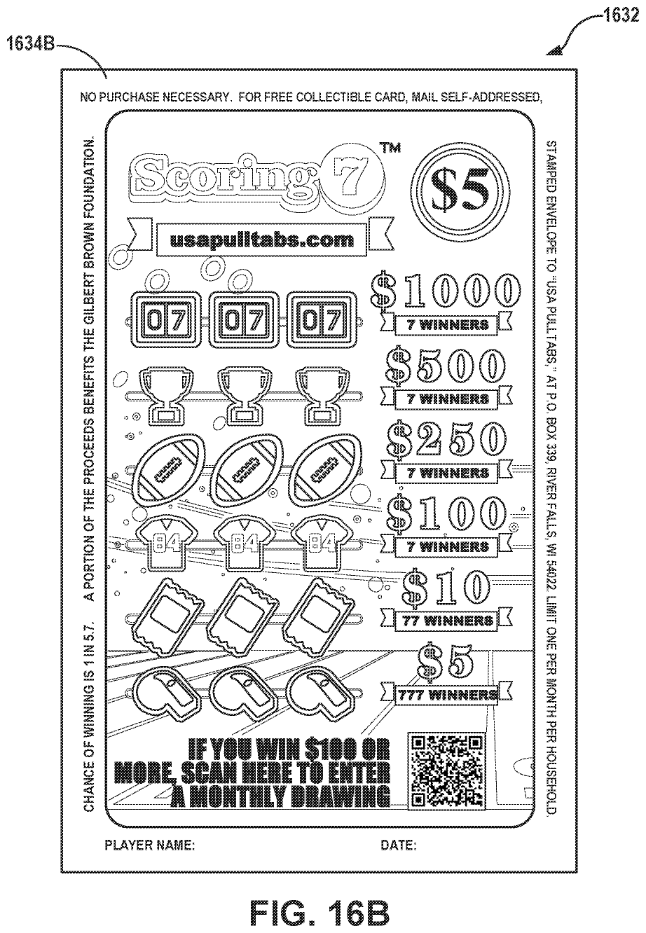

FIG. 16A shows a front side 1634A, and FIG. 16B shows a back side 1634B, of another example pulltab card 1632 that may be printed (by printer 104) and assembled as one of pulltab cards 118 of FIG. 1. Pulltab card 1632 is another example of pulltab card 232 depicted in FIGS. 3A-3C in that, while not explicitly shown, the back side 1634B includes a plurality of perforated tabs concealing respective pulltab-game entries. In the event that one of the concealed game entries is a winning entry, the back side 1634B will further feature, underneath another one of the perforated tabs, a barcode encoding a prize-verification code that may be scanned by prize-redemption kiosk 108 of FIGS. 1 and 4.

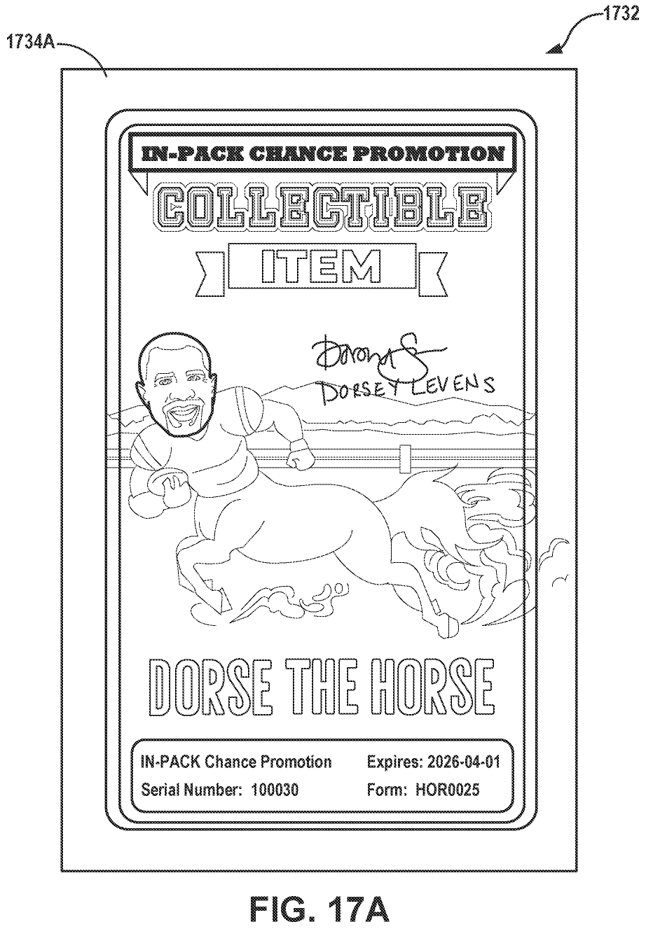

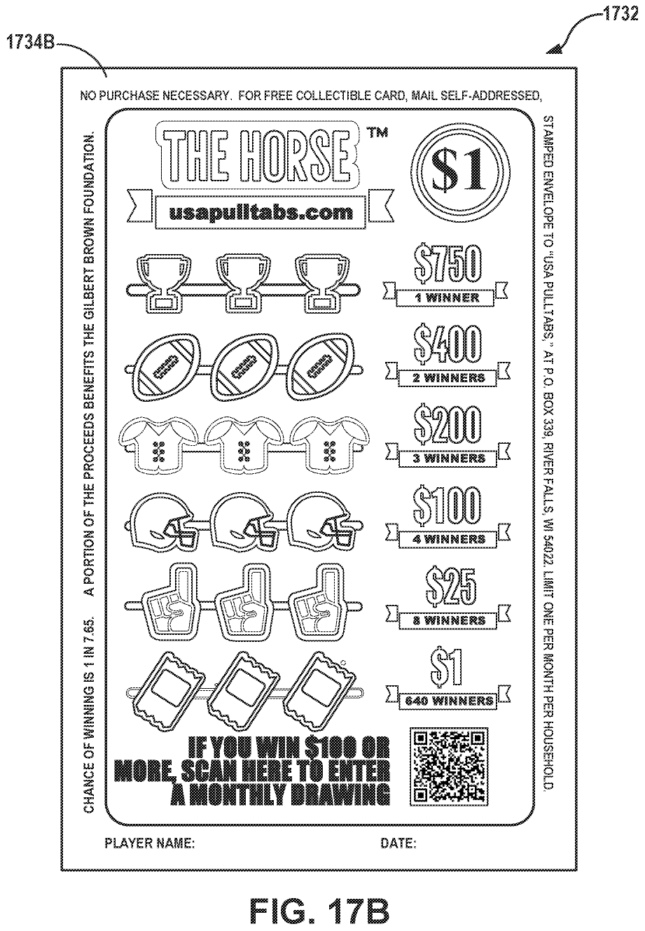

FIG. 17A shows a front side 1734A, and FIG. 17B shows a back side 1734B, of another example pulltab card 1732 that may be printed (by printer 104) and assembled as one of pulltab cards 118 of FIG. 1. Pulltab card 1732 is another example of pulltab card 232 depicted in FIGS. 3A-3C in that, while not explicitly shown, the back side 1734B includes a plurality of perforated tabs concealing respective pulltab-game entries. In the event that one of the concealed game entries is a winning entry, the back side 1734B will further feature, underneath another one of the perforated tabs, a barcode encoding a prize-verification code that may be scanned by prize-redemption kiosk 108 of FIGS. 1 and 4.

Although the systems, devices, and methods of the invention have been described in connection with the field of trading cards, card-based games, and lottery-type gaming, it can readily be appreciated that the invention is not limited solely to such fields, and can be used in other fields.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

Although the invention or elements thereof may by described in terms of vertical, horizontal, transverse (lateral), longitudinal, and the like, it should be understood that variations from the absolute vertical, horizontal, transverse, and longitudinal are also deemed to be within the scope of the invention.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc., in question is (or is not) removable.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

The embodiments above are chosen, described and illustrated so that persons skilled in the art will be able to understand the invention and the manner and process of making and using it. The descriptions and the accompanying drawings should be interpreted in the illustrative and not the exhaustive or limited sense. The invention is not intended to be limited to the exact forms disclosed. While the application attempts to disclose all of the embodiments of the invention that are reasonably foreseeable, there may be unforeseeable insubstantial modifications that remain as equivalents. It should be understood by persons skilled in the art that there may be other embodiments than those disclosed which fall within the scope of the invention as defined by the claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

What is claimed is:

1. A pulltab-game system comprising:
a vending machine configured to retain and dispense a set of pulltab cards of a pulltab game; and
a prize kiosk configured to:
identify a winning card from the set of pulltab cards; and
in response to identifying the winning card, dispense a cash prize associated with the winning card.

2. The pulltab-game system of claim 1, wherein the winning card comprises a prize-verification code, and wherein the prize kiosk is configured to redeem the cash prize by:
determining the prize-verification code of the winning card; and
verifying the prize-verification code.

3. The pulltab-game system of claim 2, wherein the prize-verification code comprises an eleven-digit numeric code.

4. The pulltab-game system of claim 2, wherein the winning card comprises a barcode encoding the prize-verification code, and wherein the prize kiosk is configured to determine the prize-verification code by scanning the barcode.

5. The pulltab-game system of claim 2, wherein the prize kiosk comprises a user interface, and wherein the prize kiosk is configured to determine the prize-verification code by receiving, via the user interface, user input comprising the prize-verification code.

6. The pulltab-game system of claim 5, wherein the user interface comprises a touchscreen.

7. The pulltab-game system of claim 2, wherein the prize kiosk is configured to verify the prize-verification code by:
retrieving, from memory, a set of game data associated with the pulltab game; and
locating the prize-verification code within the set of game data.

8. The pulltab-game system of claim 7, wherein the set of game data comprises a comma-separated values (.CSV) file comprising, for each of a plurality of winning cards of the pulltab game that includes the winning card, a set of values indicating:
a serial number of the pulltab game;
the prize-verification code;
a cash-prize denomination; and
a graphical card image displayed on a front side of the winning card.

9. The pulltab-game system of claim 7, wherein the prize kiosk is further configured to:
receive the set of game data via a removable digital storage device inserted into the prize kiosk; and
store the set of game data in memory.

10. The pulltab-game system of claim 7, wherein the prize kiosk is further configured to:
wirelessly receive the set of game data from a remote computing device; and
store the set of game data in memory.

11. The pulltab-game system of claim 1, further comprising a computing device configured to generate the pulltab game by generating:
a set of game data comprising a plurality of randomized game entries; and
a set of card graphics corresponding to the set of game data, wherein the set of pulltab cards comprises the set of card graphics.

12. The pulltab-game system of claim 11, further comprising a printer configured to print the card graphics onto sheets of cardboard for subsequent assembly into the set of pulltab cards.

13. The pulltab-game system of claim 1, further comprising the set of pulltab cards including the winning card, wherein the winning card comprises:
a plurality of perforated tabs;
a winning game entry printed underneath one of the perforated tabs; and
a prize-verification code printed underneath another one of the perforated tabs.

14. The pulltab-game system of claim 13, wherein the winning card further comprises a quick-resource (QR) code encoding a uniform resource locator (URL) of a webpage corresponding to a periodic prize drawing.

15. A prize kiosk comprising:
means for receiving data comprising a set of game data corresponding to a pulltab game;
a digital memory configured to store the set of game data;
a barcode scanner configured to scan a barcode printed under a perforated tab on a winning card of the pulltab game;
a cash dispenser; and
processing circuitry configured to:
determine a prize-verification code encoded by the barcode printed on the winning card;
locate a winning entry within the set of game data that includes the prize-verification code;
determine, from the winning entry, a prize denomination corresponding to the prize-verification code; and
cause the cash dispenser to dispense a cash prize corresponding to the prize denomination.

16. The prize kiosk of claim 15, wherein the processing circuitry is further configured to determine, based on the set of game data, that the prize-verification code has not already been redeemed, prior to causing the cash dispenser to dispense the cash prize.

17. A method comprising:
receiving, by a prize kiosk, a set of game data corresponding to a pulltab game;
storing, by the prize kiosk, the set of game data in local memory;
scanning, by a prize kiosk, a barcode printed underneath a perforated tab on a winning card of the pulltab game;
determining, based on the scanned barcode, a prize-verification code encoded by the barcode;
identifying, within the set of game data, a winning entry that comprises the prize-verification code;
determining, from the winning entry, a prize denomination associated with the prize-verification code; and
dispensing, by the prize kiosk, a cash prize corresponding to the prize denomination.

18. The method of claim 17, further comprising determining, by the prize kiosk based on the set of game data, that the prize-verification code has not already been redeemed, prior to dispensing the cash prize.

19. The method of claim 17, wherein receiving the set of game data comprises receiving the set of game data from a removable digital storage device manually inserted into the prize kiosk.

20. The method of claim 17, wherein the set of game data comprises a comma-separated values (.CSV) file comprising, for each of a plurality of winning cards of the pulltab game that includes the winning card, a set of values indicating:
a serial number of the pulltab game;
the prize-verification code;
the prize denomination; and
a graphical card image displayed on a front side of the winning card.
